(19) United States
(12) Patent Application Publication
(10) Pub. No.: US 2010/0217442 A1
(43) Pub. Date: Aug. 26, 2010

(54) DEVICE AND METHOD FOR CONTROLLING MULTIAXIAL JOINT UNIT

(75) Inventor: YUNG-SHEN LEE, Taipei Hsien (TW)

Correspondence Address: RABIN & Berdo, PC, 1101 14TH STREET, NW, SUITE 500, WASHINGTON, DC, 20005, US

(73) Assignee: MICRO-STAR INT'L CO., LTD., Taipei Hsien (TW)

(21) Appl. No.: 12/536,796

(22) Filed: Aug. 6, 2009

(30) Foreign Application Priority Data
Feb. 25, 2009 (TW) 098105951

(51) Int. Cl. G05B 19/42

(52) U.S. Cl. 700/275; 700/88; 901/5

(57) ABSTRACT

A device is provided for controlling multiaxial joint unit. The device includes a multiaxial joint unit, an estimating module, a path determining module, a path editing module. The multiaxial joint unit is to perform at least an action. The estimating module estimates parameter changes of the multiaxial joint unit while performing the action. The path determining module determines a work path according to the parameter changes. The path editing module determines multiple turning points of the work path and determines a simplified path according to the turning points, thereby controlling the multiaxial joint unit so that it moves according to the simplified path and performs the action repeatedly. A method for controlling the multiaxial joint unit is further provided.

### CROSS-REFERENCES TO RELATED APPLICATIONS

This non-provisional application claims priority under 35 U.S.C. §119(a) on Patent Application No. 98105951 filed in Taiwan, R.O.C. on Feb. 25, 2009, the entire contents of which are hereby incorporated by reference.

### BACKGROUND OF THE INVENTION

1. Technical field

The present invention relates to a control device and control method thereof, and more particularly, to a device and method for controlling a multiaxial joint unit.

2. Related Art

During the manufacturing process, electronic products are delivered on lengthwise or U-shaped conveyor belts along a production line; multiple operators are assigned to assembly the electronic products. However, this labor-intensive method of assembling electronic products is inefficient, costly, and unfavorable for quality control. Owing to increasingly high labor costs, manufacturing automation is gradually replacing labor-intensive assembly. In this regard, robotic arms play an important role in the course of manufacturing automation.

A conventional robotic arm usually follows a programmable, planned, permanent work path and performs the same action ceaselessly and repeatedly. However, the more complicated the action to be performed by the robotic arm, the more arduous is work path planning. Hence, work path planning is gradually replaced by robot teaching. The term “robot teaching” means that a robot equipped with a memory device is instructed in action procedures, positions, and speeds and taught to perform a complex action, such as extension-contraction, flexion-extension, vertical translation, horizontal translation, or rotation, anew as needed, according to a preset message from the memory device. Nonetheless, robot teaching requires that a robot be equipped with an expensive component, such as a force sensor or an accelerometer, in order to detect a force expected from the robot; this, coupled with position detection, enables the robot to make dexterous coordinated movements.

Owing to its high costs, robot teaching is applicable mostly to industrial robotic arms. Hence, an issue that calls for immediate solution is: providing a simplified system of robot teaching to enable a robot to make dexterous coordinated movements in the absence of an additional force-detection component and thereby solve the problems caused by the high costs of a conventional system of robot teaching.

### SUMMARY

In view of the aforesaid drawbacks of the prior art, the present invention provides a device for controlling a multiaxial joint unit, including: the multiaxial joint unit for performing at least an action; an estimating module for estimating a parameter change of the action to be performed by the multiaxial joint unit; a path determining module for determining a work path according to the parameter change; and a path editing module for determining a plurality of turning points of the work path and determining a simplified path according to the turning points so as to allow the multiaxial joint unit to repeat the action according to displacement attributed to the simplified path.

The present invention further provides a method for controlling a multiaxial joint unit, including steps of: performing at least an action by means of a multiaxial joint unit; estimating a parameter change of the action to be performed by the multiaxial joint unit; determining a work path according to the parameter change; determining a plurality of turning points of the work path; and determining a simplified path according to the turning points so as to allow the multiaxial joint unit to repeat the action according to displacement attributed to the simplified path.

As disclosed in the present invention, after a work path for the multiaxial joint unit has been planned, the path editing module determines a simplified path by editing the work path, thereby bringing about the following benefits: efficient reduction in data configured for description of a work path; enhanced conformity with characteristics of a servo system; and complicated action models are further created as a result of efficient integration of basic actions. The present invention provides a simplified system of robot teaching to enable a robot to make dexterous coordinated movements in the absence of an additional force-detection component, and thereby solve the problems caused by the high costs of a conventional system of robot teaching. Hence, a device and method for controlling a multiaxial joint unit according to the present invention have wide application in an articulated servo control system that entails describing plenty behavior models without using an additional sensor, such as a robotic arm, robot, or robotic dog.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus not limitative of the present invention, wherein:

FIG. 1 is a block diagram of the present invention;

FIG. 2A is a schematic view of a work path in the present invention;

FIG. 2B is a schematic view of a simplified path in the present invention;

FIG. 3A is a schematic view of two work paths before being integrated according to the present invention;

FIG. 3B is a schematic view of two work paths after being integrated according to the present invention; and

FIG. 4 is a flowchart of the method according to the present invention.

### DETAILED DESCRIPTION

Reference will now be made in detail to the present preferred embodiments of the invention, examples of which are illustrated in the accompanying drawings. Wherever possible, the same reference numbers are used in the drawings, and the description refers to the same or like parts.

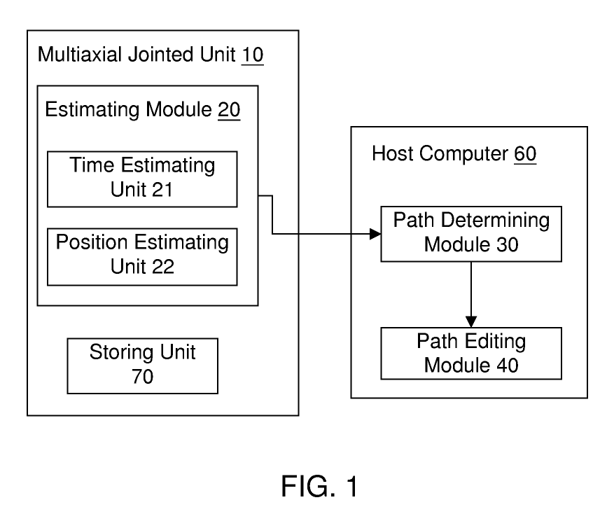

Referring to FIG. 1, a block diagram of a device for controlling a multiaxial joint unit according to the present invention is shown.

The device for controlling multiaxial joint unit according to the present invention includes: a multiaxial joint unit 10, an estimating module 20, a path determining module 30, and a path editing module 40.

The multiaxial joint unit 10 performs an action, such as extension-contraction, flexion-extension, vertical translation, horizontal translation or rotation, or performs a complicated action, such as clamping an object, dotting or welding. The multiaxial joint unit 10 is driven by a servomotor and a gear transmission module, preferably a robotic arm, or driven by a servo control system of any kind, such as a robot or a robotic dog; but the present invention is not limited thereto.

The estimating module 20 estimates parameter changes of the multiaxial joint unit 10 when performing the action. The estimating module 20 is disposed above the multiaxial joint unit 10. Preferably, the parameter change of the action performed by the multiaxial joint unit 10 includes a time change and a position change. In other words, the estimating module 20 estimates time-related information and position-related information at every moment while the multiaxial joint unit 10 is performing the action. However, the parameter change of the action performed by the multiaxial joint unit 10 according to the present invention is exemplified by rather than limited to a time change and a position change.

Preferably, the estimating module 20 includes a time estimating unit 21 and a position estimating unit 22. The time estimating unit 21 estimates a time change of an action to be performed by the multiaxial joint unit 10. The position estimating unit 22 estimates a position change of the action to be performed by the multiaxial joint unit 10.

The path determining module 30 determines a work path according to a parameter change estimated by the estimating module 20. In other words, the path determining module 30 sketches the work path for the action to be performed by the multiaxial joint unit 10, according to time-related information and position-related information at every moment while the multiaxial joint unit 10 is performing the action.

The path editing module 40 determines a plurality of turning points of the work path sketched by the path determining module 30, and determines a simplified path based on the turning points. The path editing module 40 automatically sketches a simplified path by linking the determined turning points together. Alternatively, a user selects a plurality of turning points to be linked together so that a simplified path to be sketched. In addition, the estimating module 20 estimates time-related information and position-related information at every moment while the multiaxial joint unit 10 is performing the action; hence, the turning points necessarily include time-related information and position-related information, allowing the user to use the path editing module 40 to edit time-related information or position-related information of the turning points.

In the aforesaid embodiment, the path determining module 30 and the path editing module 40 are preferably software so that the path determining module 30 and/or the path editing module 40 may be executed by a host computer 60; in this regard, the aforesaid embodiment is not supposed to limit the present invention. Alternatively, the path determining module 30 and the path editing module 40 are hardware installed on the multiaxial joint unit 10 or the host computer 60, respectively. The host computer 60 is an industrial computer, personal computer, notebook computer, or an electronic device configured for computation. The device for controlling a multiaxial joint unit according to the present invention further includes a storing unit 70 for storing a parameter change estimated by the estimating module 20; alternatively, the storing unit 70 stores the work path sketched by the path determining module 30 or the simplified path sketched by the path editing module 40. Preferably, the storing unit 70 is installed on the multiaxial joint unit 10 or the host computer 60 as needed.

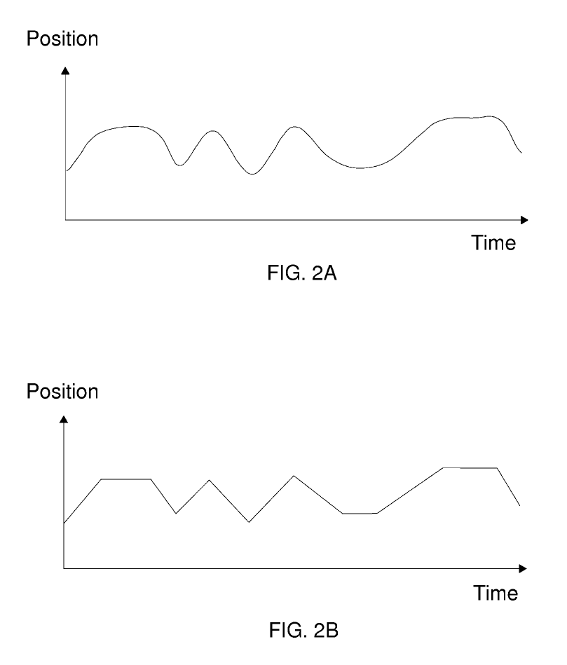

Referring to FIGS. 2A and 2B, the user can move the multiaxial joint unit 10 so that the multiaxial joint unit 10 may perform a specific action. Dexterous coordinated movement of the multiaxial joint unit 10 entails estimating a time change by the time estimating unit 21, estimating a position change by the position estimating unit 22, and storing the time-related information and position-related information into the storing unit 70 at every moment while the multiaxial joint unit 10 is performing the specific action. Upon completion of the specific action performed by the multiaxial joint unit 10, the path determining module 30 sketches a work path according to the time-related information and position-related information at every moment while the multiaxial joint unit 10 was performing the specific action (as shown in FIG. 2A). Subsequently, the path editing module 40 determines a plurality of turning points of the work path and links the turning points together so as to sketch a simplified path (as shown in FIG. 2B). With the simplified path including time-related information and position-related information of a plurality of turning points instead of time-related information and position-related information at every moment of the work path in whole, data configured for description of a work path are efficiently reduced. Afterward, the multiaxial joint unit 10 repeats the action according to displacement attributed to the simplified path sketched by the path editing module 40.

The user uses the path editing module 40 to edit time-related information or position-related information of the turning points so as to provide the well-adjusted simplified path and enable the multiaxial joint unit 10 to make dexterous coordinated movements. The user can use the path editing module 40 to duplicate a specific segment of the work path or the simplified path and put the duplicate specific segment at an appropriate position of the simplified path. In addition, the user can use the path editing module 40 to adjust the waveform of the simplified path.

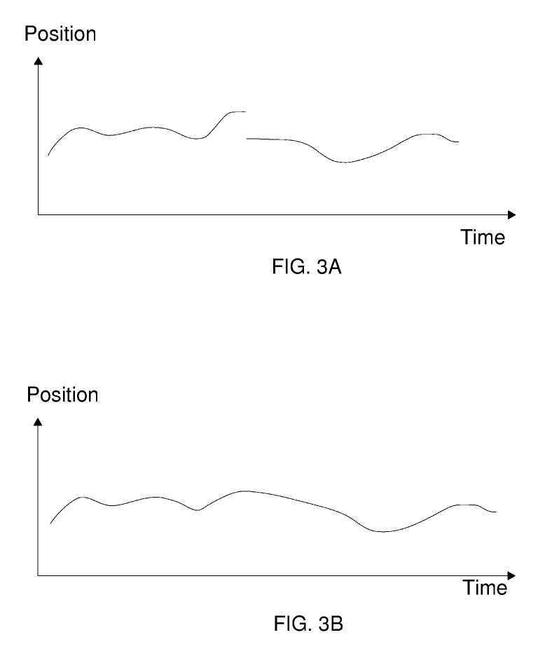

Referring to FIG. 3A and FIG. 3B, after different actions of the multiaxial joint unit 10 have been sketched to provide a plurality of simplified paths, the path editing module 40 integrates the simplified paths into a simplified path. As regards integration of different actions, joining different actions together is likely to result in discrete segments; to prevent this from occurring, discrete segments are depicted by an appropriate mathematical description method using curving fitting, after the linking of actions; in other words, to link two simplified paths, the path editing module 40 links two adjacent turning points of two simplified paths by curve fitting so that a simplified path may be determined.

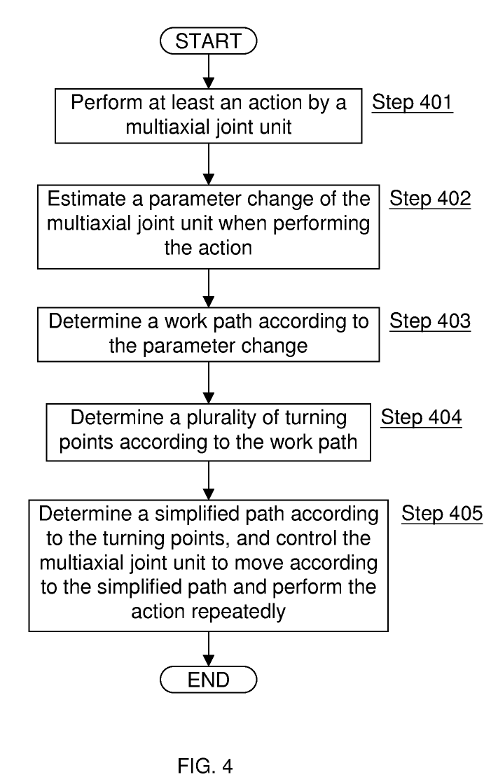

Referring to FIG. 4, a method for controlling a multiaxial joint unit of the present invention includes the following steps.

Step 401: Perform at least an action by a multiaxial joint unit 10.

The user moves the multiaxial joint unit 10 so that the multiaxial joint unit 10 may perform a specific action.

Step 402: Estimate a parameter change of the action to be performed by the multiaxial joint unit 10.

Dexterous coordinated movement of the multiaxial joint unit 10 entails estimating a time change by means of the time estimating unit 21, estimating a position change by means of the position estimating unit 22, and then storing the time-related information and position-related information into the storing unit 70 at every moment while the multiaxial joint unit 10 is performing the specific action.

Step 403: Determine a work path according to the parameter change.

Upon completion of the specific action performed by the multiaxial joint unit 10, the path determining module 30 sketches a work path according to the time-related information and position-related information at every moment while the multiaxial joint unit 10 performs the specific action (as shown in FIG. 2A).

Step 404: Determine a plurality of turning points according to the work path.

A plurality of turning points of the work path sketched by the path determining module 30 is determined by the path editing module 40; meanwhile, the turning points include the time-related information and position-related information, though the aforesaid disclosure is not supposed to limit the present invention.

Step 405: Determine a simplified path according to the turning points, and enable the multiaxial joint unit 10 to perform the action repeatedly according to displacement attributed to the simplified path.

After the turning points have been determined, the path editing module 40 links the turning points in sequence so as to sketch a simplified path (as shown in FIG. 2B). Afterward, the multiaxial joint unit 10 repeats the action according to displacement attributed to the simplified path sketched by the path editing module 40.

At this point, the path editing module 40 starts to edit the time-related information or position-related information of the turning points so as to provide the well-adjusted simplified path and enable the multiaxial joint unit 10 to make dexterous coordinated movements. Also, the path editing module 40 duplicates a specific segment of the work path or the simplified path and puts the duplicate specific segment at an appropriate position of the simplified path. Also, the path editing module 40 adjusts the waveform of the simplified path.

After different actions of the multiaxial joint unit 10 have been sketched and depicted as a plurality of simplified paths, the path editing module 40 integrates the simplified paths into a simplified path. To connect two simplified paths, the path editing module 40 uses curve fitting to link two adjacent turning points of the two simplified paths so that the two simplified paths may be integrated into a simplified path.

As disclosed in the present invention, a feedback message related to an original position is edited so that a simplified path may be created. With the simplified path including time-related information and position-related information of a plurality of turning points, the present invention has the following advantages: efficient reduction in data configured for description of a work path; enhanced conformity with characteristics of a servo system; complicated action models are further created as a result of efficient integration of basic actions; continuous and coordinated movements; and the present invention dispenses with additional force-detection components and thereby solves the problems caused by the high costs of a conventional system of robot teaching. Accordingly, a device and method for controlling a multiaxial joint unit according to the present invention have wide application in an articulated servo control system that entails describing a range of behavior models without using an additional sensor, such as a robotic arm, robot, or robotic dog.

While the present invention has been described by the way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A device for controlling multiaxial joint unit, comprising:
a multiaxial joint unit, performing at least an action;
an estimating module, estimating at least a parameter change of the multiaxial joint unit when performing the action;
a path determining module, determining a work path according to the parameter change; and
a path editing module, determining a plurality of turning points of the work path and determining a simplified path according to the turning points, so that the multiaxial joint unit may be controlled to move according to the simplified path and perform the action repeatedly.

2. The device of claim 1 further comprising a storing unit for storing the parameter change.

3. The device of claim 1, further comprising a host computer for executing at least one of the path determining module and the path editing module.

4. The device of claim 1, wherein the parameter change comprises a time change and a position change.

5. The device of claim 4, wherein the estimating module comprises a time estimating unit for estimating the time change.

6. The device of claim 4, wherein the estimating module comprises a position estimating unit for estimating the position change.

7. The device of claim 1, wherein the turning points comprise time-related information and position-related information.

8. The device of claim 7, wherein the path editing module edits the time-related information of the turning points.

9. The device of claim 7, wherein the path editing module edits the position-related information of the turning points.

10. The device of claim 1, wherein the path editing module determines the simplified path by linking the turning points together.

11. The device of claim 1, wherein the path editing module links two of said simplified paths as one by curve fitting and linking two adjacent ones of the turning points on the two simplified paths.

12. A method for controlling a multiaxial joint unit, comprising steps of:
performing at least an action by a multiaxial joint unit;
estimating at least a parameter change of the multiaxial joint unit when performing the action;
determining a work path according to the parameter change;
determining a plurality of turning points of the work path; and
determining a simplified path according to the turning points, thereby controlling the multiaxial joint unit to move according to the simplified path and perform the action repeatedly.

13. The method of claim 12, wherein the step of estimating the parameter change is followed by a step of storing the parameter change.

14. The method of claim 12, wherein the parameter change comprises a time change and a position change.

15. The method of claim 12, wherein the turning points comprise time-related information and position-related information.

16. The method of claim 15, wherein the step of determining the simplified path comprises editing the time-related information of the turning points.

17. The method of claim 15, wherein the step of determining the simplified path comprises editing the position-related information of the turning points.

18. The method of claim 12, wherein the step of determining the simplified path comprises linking the turning points to form the simplified path.

19. The method of claim 12, wherein the step of determining the simplified path further comprises the step of linking the work paths of two said actions.

20. The method of claim 19, wherein the step of determining the simplified path comprises linking two of said simplified paths as one by curve fitting and linking two adjacent ones of the turning points on the two simplified paths.
